(19) United States
(12) Patent Application Publication
(10) Pub. No.: US 2025/0254627 A1
(43) Pub. Date: Aug. 7, 2025

(54) ADAPTIVE POWER CONTROL AS A DESENSE MITIGATION IN A MULTI-SUBSCRIBER IDENTIFY MODULE (MSIM) APPLICATION

(71) Applicant: QUALCOMM Incorporated, San Diego, CA (US)

(72) Inventors: Saranyan NAGARAJAN, Hyderabad (IN); Srinivas PACHAVA, Hyderabad (IN); Prasidh RAMABADRAN, Bangalore (IN); Sriramgopal SRIDHARA, San Diego, CA (US); Lan LAN, San Diego, CA (US); Qingxin CHEN, San Diego, CA (US); Priyangshu GHOSH, Hyderabad (IN); Mahim RANJAN, San Diego, CA (US); Ehab ABDEL GHANY, San Diego, CA (US)

(21) Appl. No.: 18/430,318

(22) Filed: Feb. 1, 2024

(51) Int. Cl. H04W 52/24; H04W 52/22

(52) U.S. Cl. CPC H04W 52/241; H04W 52/228

(57) ABSTRACT

Certain aspects of the present disclosure are directed towards methods and apparatus for wireless communication. An example method generally includes: determining a first transmit power to facilitate decoding of a page signal; receiving, for a time duration, the page signal using a first receive chain; and performing a transmission using the first transmit power during the time duration in which the page signal is being received, wherein the transmission is performed using a second transmit power after the time duration, the second transmit power being greater than the first transmit power.

### TECHNICAL FIELD

Certain aspects of the present disclosure generally relate to electronic circuits and, more particularly, to techniques for facilitating reception of page signals.

### BACKGROUND

Wireless communication devices are widely deployed to provide various communication services such as telephony, video, data, messaging, broadcasts, and so on. Such wireless communication devices may transmit and/or receive radio frequency (RF) signals via any of various suitable radio access technologies (RATs) including, but not limited to, Fifth Generation (5G) New Radio (NR), Long Term Evolution (LTE), Code Division Multiple Access (CDMA), Time Division Multiple Access (TDMA), Wideband CDMA (WCDMA), Global System for Mobility (GSM), Bluetooth, Bluetooth Low Energy (BLE), ZigBee, wireless local area network (WLAN) RATs (e.g., WiFi), and the like.

A wireless communication network may include a number of base stations that can support communication for a number of mobile stations. A mobile station (MS) may communicate with a base station (BS) via a downlink and an uplink. The downlink (or forward link) refers to the communication link from the base station to the mobile station, and the uplink (or reverse link) refers to the communication link from the mobile station to the base station. A base station may transmit data and control information on the downlink to a mobile station and/or may receive data and control information on the uplink from the mobile station. The base station and/or mobile station may include one or more frequency synthesizers.

### SUMMARY

The systems, methods, and devices of the disclosure each have several aspects, no single one of which is solely responsible for its desirable attributes. Without limiting the scope of this disclosure as expressed by the claims which follow, some features will now be discussed briefly. After considering this discussion, and particularly after reading the section entitled “Detailed Description,” one will understand how the features of this disclosure provide advantages that include reduced area and power consumption.

Certain aspects of the present disclosure are directed towards a method for wireless communication. The method generally includes: determining a first transmit power to facilitate decoding of a page signal; receiving, for a time duration, the page signal using a first receive chain; and performing a transmission using the first transmit power during the time duration in which the page signal is being received, wherein the transmission is performed using a second transmit power before and/or after the time duration, the second transmit power being greater than the first transmit power.

Certain aspects of the present disclosure are directed towards an apparatus for wireless communication. The apparatus generally includes a memory and one or more processors coupled to the memory, the one or more processors being configured to: determine a first transmit power to facilitate decoding of a page signal, wherein the page signal is configured to be received for a time duration using a first receive chain; and cause a transmission to be performed using the first transmit power during the time duration in which the page signal is being received, wherein the transmission is caused to be performed using a second transmit power before and/or after the time duration, the second transmit power being greater than the first transmit power.

Certain aspects of the present disclosure are directed towards a non-transitory computer-readable medium having instructions stored thereon, that when executed by one or more processors, cause the one or more processors to: determine a first transmit power to facilitate decoding of a page signal, wherein the page signal is configured to be received for a time duration using a first receive chain; and cause a transmission to be performed using the first transmit power during the time duration in which the page signal is being received, wherein the transmission is caused to be performed using a second transmit power before and/or after the time duration, the second transmit power being greater than the first transmit power.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects.

FIG. 1 is a diagram of an example wireless communications network, in which aspects of the present disclosure may be practiced.

FIG. 2 is a block diagram conceptually illustrating a design of an example base station (BS) and user equipment (UE), in which aspects of the present disclosure may be practiced.

FIG. 3 is a block diagram of an example radio frequency (RF) transceiver, in which aspects of the present disclosure may be practiced.

FIG. 4 illustrates a wireless device including transmit and receive chains for a first subscriber and a receive chain for a second subscriber.

FIG. 5 illustrates transmit and receive powers in a frequency domain.

FIG. 6 illustrates the frequency overlap of transmissions and receptions for different bands.

FIG. 7 is a graph having a curve representing a level of transmit power interference at a receiver, in accordance with certain aspects of the present disclosure.

FIG. 8 illustrates a service component used to calculate a transmission power backoff level, in accordance with certain aspects of the present disclosure.

FIG. 9 illustrates an intermodulation product that causes down-conversion of a transmitted signal appearing at an input of a receive chain.

FIGS. 10 and 11 are tables indicating example band combinations that may be associated with respective transmission backoff levels, in accordance with certain aspects of the present disclosure.

FIG. 12 is a flow diagram illustrating example operations for wireless communication, in accordance with certain aspects of the present disclosure.

To facilitate understanding, identical reference numerals have been used, where possible, to designate identical elements that are common to the figures. It is contemplated that elements disclosed in one aspect may be beneficially utilized on other aspects without specific recitation.

### DETAILED DESCRIPTION

Certain aspects of the present disclosure are directed towards facilitating a multi-subscriber identify module (SIM) (MSIM) (e.g., dual-SIM-dual-Standby (DSDS)) implementation. Some aspects provide for dynamically determining a power level at which to back off a transmission power level (referred to herein as “Tx backoff”) associated with a first subscriber to allow a page decode on a receiver chain of a second subscriber. In some aspects, a threshold determination model may be implemented to compute (e.g., using an equation) potential desense and a corresponding Tx backoff amount.

Transmission backoff may be used as a mitigation scheme to avoid desense in a receiver (e.g., for dual-receive (DR)-dual-SIM-dual-standby (DSDS) and DSDA implementations) where aggressor and victim bands are related through a harmonic relation. A DSDS device may transmit a signal for a first subscription (Sub1) while receiving a signal for a second subscription (Sub2). Desense refers to a situation where the sensitivity of a wireless receiver to incoming signals is reduced due to electromagnetic interference. In some implementations, the amount of transmission power backoff may be implemented using static tables, where MSIM band combinations are indicated along with (e.g., mapped to) fixed transmission power backoff levels.

Certain aspects of the present disclosure are directed towards using a Tx backoff scheme, where the backoff is based on channel locations (e.g., operating bands) associated with transmission on Sub1 and reception on Sub2. For example, the frequency separation associated with transmissions and receptions may be computed on the fly, and backoff may be estimated to avoid desense in the receiver. Thus, backoff may be specific to the resolution of the absolute radio-frequency channel number (ARFCN).

Certain aspects of the present disclosure are directed towards performing Tx backoff for decoding a page. Certain aspects are especially valuable for receiver synthesizers used for page decode that are implemented for low cost and low area consumption. For example, ring oscillator-based synthesizers may be smaller in area and hence cost less when compared to inductor-capacitor (LC) oscillators but have poor phase noise performance. As a result, when transmission of Sub1 interferes with the receiver of Sub2 due to the lack of isolation between the transmitter and receiver, the reciprocal mixing of the transmission with the poor skirt (e.g., phase noise skirt of the receive local oscillator) of the Sub2 receiver synthesizer creates noise that falls within the channel of the Sub2 reception, leading to desense and potential loss of page. Reciprocal mixing refers to noise generated within receivers as a result of mixing phase noise appearing on local oscillator signals with a Jammer signal.

Certain aspects are directed towards backing off the transmission adaptively based on the channel separation of the transmission of Sub1 and the reception of Sub2, enabling the ability to design low-area and low-cost transceivers. During a page decode, the Tx backoff may be performed for a short duration in the order of a few milliseconds, resulting in an increased uplink (UL) block error rate (BLER). However, due to the short duration over which the backoff is performed, the increased BLER may not lead to a call drop. That is, there is enough error correction built into communication systems in the UL for the link to recover and be sustained.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

The word “exemplary” is used herein to mean “serving as an example, instance, or illustration.” Any aspect described herein as “exemplary” is not necessarily to be construed as preferred or advantageous over other aspects.

As used herein, the term “connected with” in the various tenses of the verb “connect” may mean that element A is directly connected to element B or that other elements may be connected between elements A and B (i.e., that element A is indirectly connected with element B). In the case of electrical components, the term “connected with” may also be used herein to mean that a wire, trace, or other electrically conductive material is used to electrically connect elements A and B (and any components electrically connected therebetween).

### An Example Wireless System

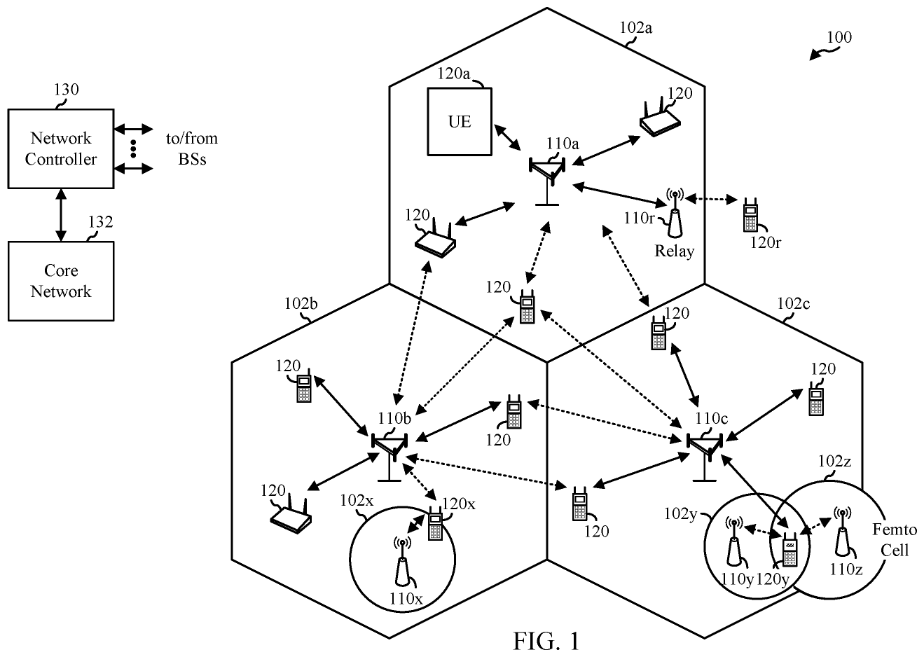

FIG. 1 illustrates an example wireless communications network 100, in which aspects of the present disclosure may be practiced. For example, the wireless communications network 100 may be a New Radio (NR) system (e.g., a Fifth Generation (5G) NR network), an Evolved Universal Terrestrial Radio Access (E-UTRA) system (e.g., a Fourth Generation (4G) network), a Universal Mobile Telecommunications System (UMTS) (e.g., a Second Generation/Third Generation (2G/3G) network), or a code division multiple access (CDMA) system (e.g., a 2G/3G network), or may be configured for communications according to an IEEE standard such as one or more of the 802.11 standards, etc.

As illustrated in FIG. 1, the wireless communications network 100 may include a number of base stations (BSs) 110a-z (each also individually referred to herein as “BS 110” or collectively as “BSs 110”) and other network entities. A BS may also be referred to as an access point (AP), an evolved Node B (eNodeB or eNB), a next generation Node B (gNodeB or gNB), or some other terminology.

A BS 110 may provide communication coverage for a particular geographic area, sometimes referred to as a “cell,” which may be stationary or may move according to the location of a mobile BS. In some examples, the BSs 110 may be interconnected to one another and/or to one or more other BSs or network nodes (not shown) in wireless communications network 100 through various types of backhaul interfaces (e.g., a direct physical connection, a wireless connection, a virtual network, or the like) using any suitable transport network. In the example shown in FIG. 1, the BSs 110a, 110b, and 110c may be macro BSs for the macro cells 102a, 102b, and 102c, respectively. The BS 110x may be a pico BS for a pico cell 102x. The BSs 110y and 110z may be femto BSs for the femto cells 102y and 102z, respectively. A BS may support one or multiple cells.

The BSs 110 communicate with one or more user equipment's (UEs) 120a-y (each also individually referred to herein as “UE 120” or collectively as “UEs 120”) in the wireless communications network 100. A UE may be fixed or mobile and may also be referred to as a user terminal (UT), a mobile station (MS), an access terminal, a station (STA), a client, a wireless device, a mobile device, or some other terminology. A user terminal may be a wireless device, such as a cellular phone, a smartphone, a personal digital assistant (PDA), a handheld device, a wearable device, a wireless modem, a laptop computer, a tablet, a personal computer, etc.

The BSs 110 are considered transmitting entities for the downlink and receiving entities for the uplink. The UEs 120 are considered transmitting entities for the uplink and receiving entities for the downlink. As used herein, a “transmitting entity” is an independently operated apparatus or device capable of transmitting data via a frequency channel, and a “receiving entity” is an independently operated apparatus or device capable of receiving data via a frequency channel. In the following description, the subscript “dn” denotes the downlink, the subscript “up” denotes the uplink. Nᵤₚ UEs may be selected for simultaneous transmission on the uplink, N_{dn} UEs may be selected for simultaneous transmission on the downlink. Nᵤₚ may or may not be equal to N_{dn}, and Nᵤₚ and N_{dn} may be static values or can change for each scheduling interval. Beam-steering or some other spatial processing technique may be used at the BSs 110 and/or UEs 120.

The UEs 120 (e.g., 120x, 120y, etc.) may be dispersed throughout the wireless communications network 100, and each UE 120 may be stationary or mobile. The wireless communications network 100 may also include relay stations (e.g., relay station 110r), also referred to as relays or the like, that receive a transmission of data and/or other information from an upstream station (e.g., a BS 110a or a UE 120r) and send a transmission of the data and/or other information to a downstream station (e.g., a UE 120 or a BS 110), or that relays transmissions between UEs 120, to facilitate communication between devices.

The BSs 110 may communicate with one or more UEs 120 at any given moment on the downlink and uplink. The downlink (i.e., forward link) is the communication link from the BSs 110 to the UEs 120, and the uplink (i.e., reverse link) is the communication link from the UEs 120 to the BSs 110. A UE 120 may also communicate peer-to-peer with another UE 120.

The wireless communications network 100 may use multiple transmit and multiple receive antennas for data transmission on the downlink and uplink. BSs 110 may be equipped with a number Nₐₚ of antennas to achieve transmit diversity for downlink transmissions and/or receive diversity for uplink transmissions. A set Nᵤ of UEs 120 may receive downlink transmissions and transmit uplink transmissions. Each UE 120 may transmit user-specific data to and/or receive user-specific data from the BSs 110. In general, each UE 120 may be equipped with one or multiple antennas. The Nᵤ UEs 120 can have the same or different numbers of antennas.

The wireless communications network 100 may be a time division duplex (TDD) system or a frequency division duplex (FDD) system. For a TDD system, the downlink and uplink share the same frequency band. For an FDD system, the downlink and uplink use different frequency bands. The wireless communications network 100 may also utilize a single carrier or multiple carriers for transmission. Each UE 120 may be equipped with a single antenna (e.g., to keep costs down) or multiple antennas (e.g., where the additional cost can be supported).

A network controller 130 (also sometimes referred to as a “system controller”) may be in communication with a set of BSs 110 and provide coordination and control for these BSs 110 (e.g., via a backhaul). In certain cases (e.g., in a 5G NR system), the network controller 130 may include a centralized unit (CU) and/or a distributed unit (DU). In certain aspects, the network controller 130 may be in communication with a core network 132 (e.g., a 5G Core Network (5 GC)), which provides various network functions such as Access and Mobility Management, Session Management, User Plane Function, Policy Control Function, Authentication Server Function, Unified Data Management, Application Function, Network Exposure Function, Network Repository Function, Network Slice Selection Function, etc.

In certain aspects of the present disclosure, the BSs 110 and/or the UEs 120 may include a transceiver implemented with Tx backoff to facilitate reception of a page signal.

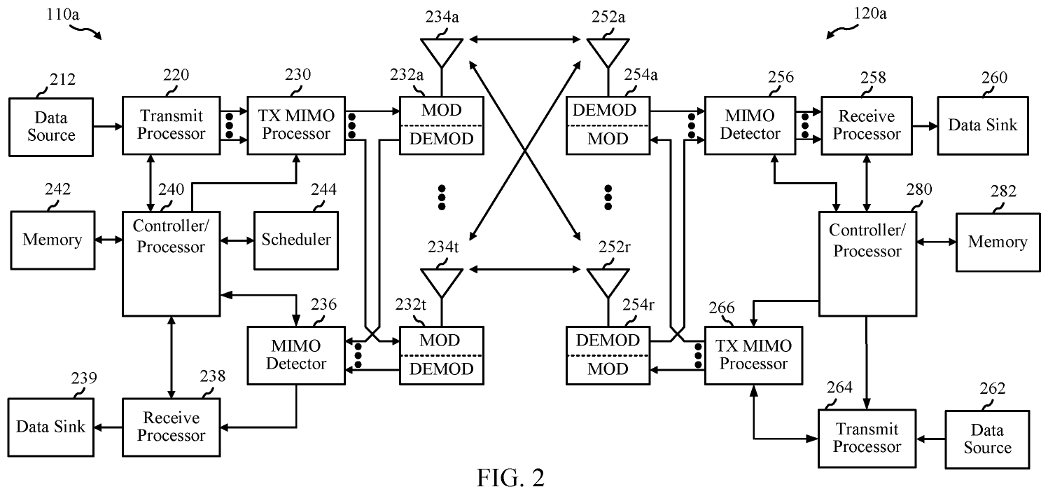

FIG. 2 illustrates example components of BS 110a and UE 120a (e.g., from the wireless communications network 100 of FIG. 1), in which aspects of the present disclosure may be implemented.

On the downlink, at the BS 110a, a transmit processor 220 may receive data from a data source 212, control information from a controller/processor 240, and/or possibly other data (e.g., from a scheduler 244). The various types of data may be sent on different transport channels. For example, the control information may be designated for the physical broadcast channel (PBCH), physical control format indicator channel (PCFICH), physical hybrid automatic repeat request (HARQ) indicator channel (PHICH), physical downlink control channel (PDCCH), group common PDCCH (GC PDCCH), etc. The data may be designated for the physical downlink shared channel (PDSCH), etc. A medium access control (MAC)-control element (MAC-CE) is a MAC layer communication structure that may be used for control command exchange between wireless nodes. The MAC-CE may be carried in a shared channel such as a PDSCH, a physical uplink shared channel (PUSCH), or a physical sidelink shared channel (PSSCH).

The processor 220 may process (e.g., encode and symbol map) the data and control information to obtain data symbols and control symbols, respectively. The transmit processor 220 may also generate reference symbols, such as for the primary synchronization signal (PSS), secondary synchronization signal (SSS), PBCH demodulation reference signal (DMRS), and channel state information reference signal (CSI-RS).

A transmit (TX) multiple-input, multiple-output (MIMO) processor 230 may perform spatial processing (e.g., precoding) on the data symbols, the control symbols, and/or the reference symbols, if applicable, and may provide output symbol streams to the modulators (MODs) in transceivers 232a-232t. Each modulator in transceivers 232a-232t may process a respective output symbol stream (e.g., for orthogonal frequency division multiplexing (OFDM), etc.) to obtain an output sample stream. Each of the transceivers 232a-232t may further process (e.g., convert to analog, amplify, filter, and upconvert) the output sample stream to obtain a downlink signal. Downlink signals from the transceivers 232a-232t may be transmitted via the antennas 234a-234t, respectively.

At the UE 120a, the antennas 252a-252r may receive the downlink signals from the BS 110a and may provide received signals to the transceivers 254a-254r, respectively. The transceivers 254a-254r may condition (e.g., filter, amplify, downconvert, and digitize) a respective received signal to obtain input samples. Each demodulator (DEMOD) in the transceivers 232a-232t may further process the input samples (e.g., for OFDM, etc.) to obtain received symbols. A MIMO detector 256 may obtain received symbols from all the demodulators in transceivers 254a-254r, perform MIMO detection on the received symbols if applicable, and provide detected symbols. A receive processor 258 may process (e.g., demodulate, deinterleave, and decode) the detected symbols, provide decoded data for the UE 120a to a data sink 260, and provide decoded control information to a controller/processor 280.

On the uplink, at UE 120a, a transmit processor 264 may receive and process data (e.g., for the physical uplink shared channel (PUSCH)) from a data source 262 and control information (e.g., for the physical uplink control channel (PUCCH)) from the controller/processor 280. The transmit processor 264 may also generate reference symbols for a reference signal (e.g., the sounding reference signal (SRS)). The symbols from the transmit processor 264 may be precoded by a TX MIMO processor 266 if applicable, further processed by the modulators (MODs) in transceivers 254a-254r (e.g., for single-carrier frequency division multiplexing (SC-FDM), etc.), and transmitted to the BS 110a. At the BS 110a, the uplink signals from the UE 120a may be received by the antennas 234, processed by the demodulators in transceivers 232a-232t, detected by a MIMO detector 236 if applicable, and further processed by a receive processor 238 to obtain decoded data and control information sent by the UE 120a. The receive processor 238 may provide the decoded data to a data sink 239 and the decoded control information to the controller/processor 240.

The memories 242 and 282 may store data and program codes for BS 110a and UE 120a, respectively. The memories 242 and 282 may also interface with the controllers/processors 240 and 280, respectively. A scheduler 244 may schedule UEs for data transmission on the downlink and/or uplink.

In certain aspects of the present disclosure, the transceivers 232 and/or the transceivers 254 may be implemented with Tx backoff to facilitate reception of a page signal.

NR may utilize orthogonal frequency division multiplexing (OFDM) with a cyclic prefix (CP) on the uplink and downlink. NR may support half-duplex operation using time division duplexing (TDD). OFDM and single-carrier frequency division multiplexing (SC-FDM) partition the system bandwidth into multiple orthogonal subcarriers, which are also commonly referred to as tones, bins, etc. Each subcarrier may be modulated with data. Modulation symbols may be sent in the frequency domain with OFDM and in the time domain with SC-FDM. The spacing between adjacent subcarriers may be fixed, and the total number of subcarriers may be dependent on the system bandwidth. The system bandwidth may also be partitioned into subbands. For example, a subband may cover multiple resource blocks (RBs).

### Example RF Transceiver

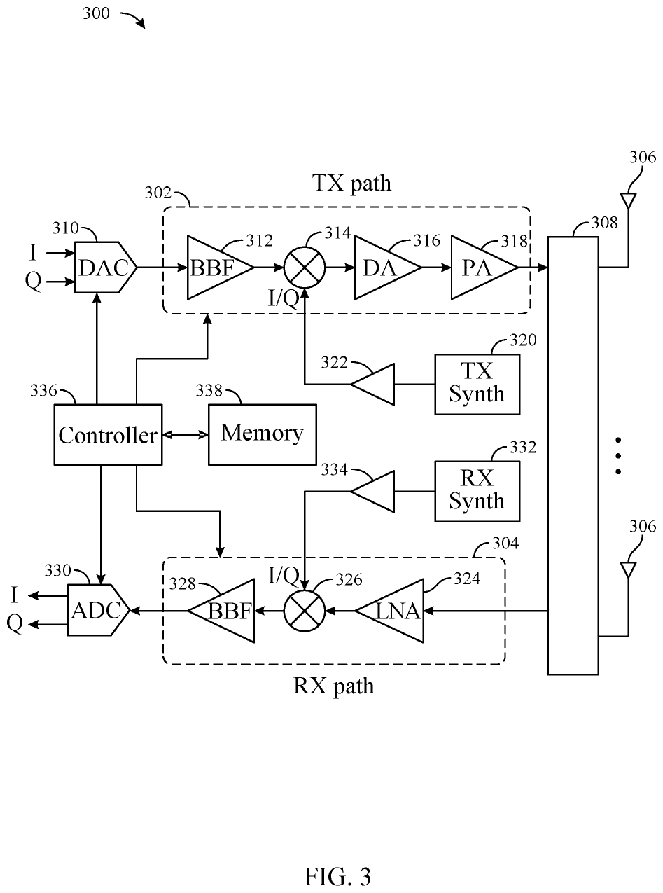

FIG. 3 is a block diagram of an example radio frequency (RF) transceiver circuit 300, in accordance with certain aspects of the present disclosure. The RF transceiver circuit 300 includes at least one transmit (TX) path 302 (also known as a “transmit chain”) for transmitting signals via one or more antennas 306 and at least one receive (RX) path 304 (also known as a “receive chain”) for receiving signals via the antennas 306. When the TX path 302 and the RX path 304 share an antenna 306, the paths may be connected with the antenna via an interface 308, which may include any of various suitable RF devices, such as a switch, a duplexer, a diplexer, a multiplexer, and the like.

Receiving in-phase (I) and/or quadrature (Q) baseband analog signals from a digital-to-analog converter (DAC) 310, the TX path 302 may include a baseband filter (BBF) 312, a mixer 314, a driver amplifier (DA) 316, and a power amplifier (PA) 318. The BBF 312, the mixer 314, the DA 316, and the PA 318 may be included in a radio frequency integrated circuit (RFIC). For certain aspects, the PA 318 may be external to the RFIC.

The BBF 312 filters the baseband signals received from the DAC 310, and the mixer 314 mixes the filtered baseband signals with a transmit local oscillator (LO) signal to convert the baseband signal of interest to a different frequency (e.g., upconvert from baseband to a radio frequency). This frequency-conversion process produces the sum and difference frequencies between the LO frequency and the frequencies of the baseband signal of interest. The sum and difference frequencies are referred to as the “beat frequencies.” The beat frequencies are typically in the RF range, such that the signals output by the mixer 314 are typically RF signals, which may be amplified by the DA 316 and/or by the PA 318 before transmission by the antenna(s) 306. While one mixer 314 is illustrated, several mixers may be used to upconvert the filtered baseband signals to one or more intermediate frequencies and to thereafter upconvert the intermediate frequency (IF) signals to a frequency for transmission.

The RX path 304 may include a low noise amplifier (LNA) 324, a mixer 326, and a baseband filter (BBF) 328. The LNA 324, the mixer 326, and the BBF 328 may be included in one or more RFICs, which may or may not be the same RFIC that includes the TX path components. RF signals received via the antenna(s) 306 may be amplified by the LNA 324, and the mixer 326 mixes the amplified RF signals with a receive local oscillator (LO) signal to convert the RF signal of interest to a different baseband frequency (e.g., downconvert). The baseband signals output by the mixer 326 may be filtered by the BBF 328 before being converted by an analog-to-digital converter (ADC) 330 to digital I and/or Q signals for digital signal processing.

Certain transceivers may employ frequency synthesizers with a variable-frequency oscillator (e.g., a voltage-controlled oscillator (VCO) or a digitally controlled oscillator (DCO)) to generate a stable, tunable LO with a particular tuning range. Thus, the transmit LO may be produced by a TX frequency synthesizer 320, which may be buffered or amplified by amplifier 322 before being mixed with the baseband signals in the mixer 314. Similarly, the receive LO may be produced by an RX frequency synthesizer 332, which may be buffered or amplified by amplifier 334 before being mixed with the RF signals in the mixer 326. For certain aspects, a single frequency synthesizer may be used for both the TX path 302 and the RX path 304. In certain aspects, the TX frequency synthesizer 320 and/or RX frequency synthesizer 332 may include a frequency divider/multipler that is driven by an oscillator (e.g., a VCO) in the frequency synthesizer. In some aspects, the transceiver circuit 300 may be implemented with a Tx backoff to facilitate the reception of a page signal.

A controller 336 (e.g., controller/processor 280 in FIG. 2) may direct the operation of the RF transceiver circuit 300A, such as transmitting signals via the TX path 302 and/or receiving signals via the RX path 304. The controller 336 may be a processor, a digital signal processor (DSP), an application-specific integrated circuit (ASIC), a field-programmable gate array (FPGA) or other programmable logic device (PLD), discrete gate or transistor logic, discrete hardware components, or any combination thereof. A memory 338 (e.g., memory 282 in FIG. 2) may store data and/or program codes for operating the RF transceiver circuit 300. The controller 336 and/or the memory 338 may include control logic (e.g., complementary metal-oxide-semiconductor (CMOS) logic).

While FIGS. 1-3 provide wireless communications as an example application in which certain aspects of the present disclosure may be implemented to facilitate understanding, certain aspects described herein may be used for any of various other suitable systems.

### Example Techniques for Page Reception

Some transceivers (e.g., having synthesizers that use ring oscillators) may have poor phase noise, which causes reciprocal mixing of the phase noise skirt (e.g., around the Rx local oscillator) of the synthesizer with a transmission signal in a frequency-division duplexing (FDD) band, which may lead to desensitization of the receiver. The problem becomes more pronounced when similar synthesizers are used for page decode in radio frequency (RF) transceivers for multi-subscriber identify module (SIM) (MSIM) applications (e.g., dual-receive-dual-SIM-dual-standby (DR-DSDS)) because the transmission of a first subscriber (Sub1) and reception of a second subscriber (Sub2) may be close in frequency. As the reception frequency of Sub2 gets closer to the transmission frequency, reciprocal mixing effects make it difficult to decode a page because of high reciprocal mixing noise. In certain aspects of the present disclosure, the reciprocal mixing noise caused by the transmission on a Sub2 receiver path may be computed. The transmission power level may be reduced to a level that causes the reciprocal mixing noise to be at least 6 dB below the total noise floor due to remaining noise sources.

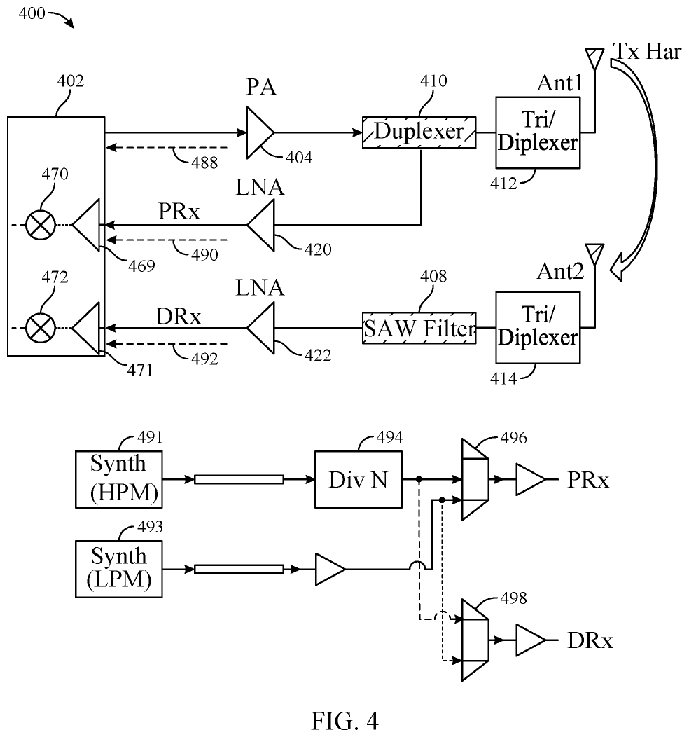

FIG. 4 illustrates a wireless device 400 including transmit and receive chains (e.g., TX path 302 and RX path 304 of FIG. 3) for Sub1 and a receive chain (e.g., RX path 304 of FIG. 3) for Sub2. The wireless device 400 includes a radio 402 which may be implemented on a chip (e.g., integrated circuit (IC)). The radio 402 includes transmit and receive circuitry. The wireless device 400 includes a transmit chain 488 for Sub1 including a power amplifier (PA) 404, a receive chain 490 for Sub1 including a low-noise amplifier (LNA) 420, and a receive chain 492 for Sub2 including an LNA 422. Receive chains 490, 492 may be used to implement a primary receiver (PRx) and a diversity receiver (DRx), respectively. For Sub1, the radio 402 may generate a signal to be amplified by PA 404 of transmit chain 488 for transmission via antenna Ant1.

As shown, a duplexer 410 may be coupled between the TX and RX chains 488, 490. A triplexer or diplexer 412 may be coupled between the duplexer 410 and the antenna Ant1. A triplexer or diplexer 414 and a SAW filter 408 may be coupled between antenna Ant2 and LNA 422 of the chain 492. As shown, the chains 490, 492 include respective LNAs 469, 471 and respective mixers 470, 472 for down-conversion of respective receive signals.

In some aspects, the wireless device 400 may include multiple synthesizers 491, 493, such as a low-power mode (LPM) synthesizer 493 (e.g., implemented using a ring oscillator) and a high-performance synthesizer (HPM) 491. The LO signal from synthesizer 491 may be provided to multiplexers 496, 498 (e.g., through a frequency divider 494, labeled “Div N”), and the LO signal from synthesizer 493 may be provided to multiplexer 496, 498. The multiplexers 496, 498 may be controlled to direct each LO signal to either the PRx or DRx chain (e.g., to either mixer 470 for chain 490 or mixer 472 for chain 492 for down-conversion) or to both PRx and DRx in case of diversity reception in non-MSIM mode.

One of the receiver chains (e.g., chain 490) may be used for traffic, and the other receive chain (e.g., chain 492) may be used for page decode. The receive chain used for traffic may use a high-performance synthesizer (e.g., synthesizer 491 using an inductor-capacitor (LC) oscillator) with good phase noise. The receive chain used for page decode may use the low-performance synthesizer (e.g., synthesizer 493 using a ring oscillator) with poor phase noise to save the transceiver's power, area, and cost.

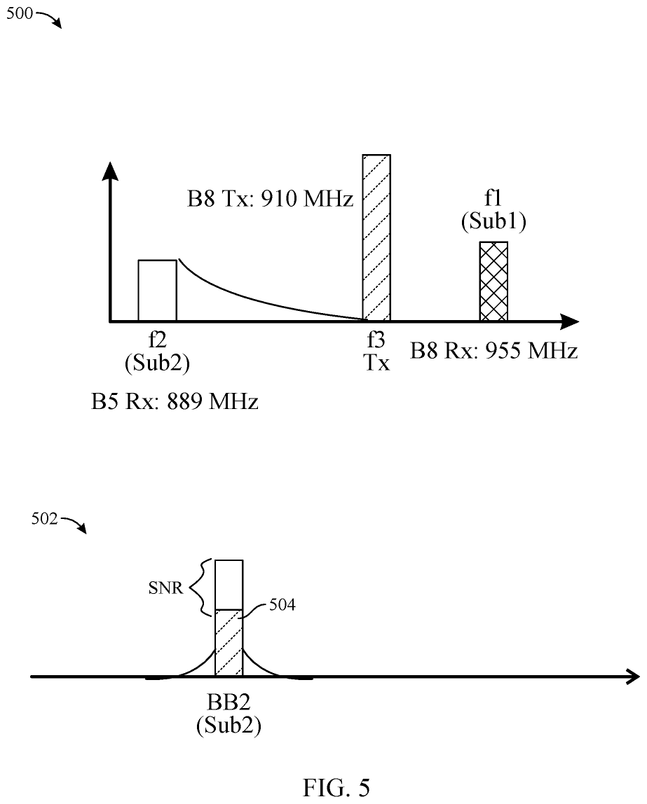

FIG. 5 illustrates transmit and receive powers in the frequency domain. For example, as shown in graph 500, a reception may occur for Sub1 at a first frequency f1 (e.g., using band 8 (B8) at 955 MHz), and a reception may occur for Sub2 at a second frequency f2 (e.g., using band 5 (B5) at 889 MHz). A transmission may occur at a third frequency f3 (e.g., using B8 at 910 MHz). As shown in graph 502, due to the skirt associated with the reception of Sub2, the transmission signal may interfere (e.g., couple noise 504) with the received signal, causing a reduction in the signal-to-noise ratio (SNR) for page reception. Thus, the reciprocal mixing of the low-power synthesizer skirt with the Sub1 transmission desenses the received page signal.

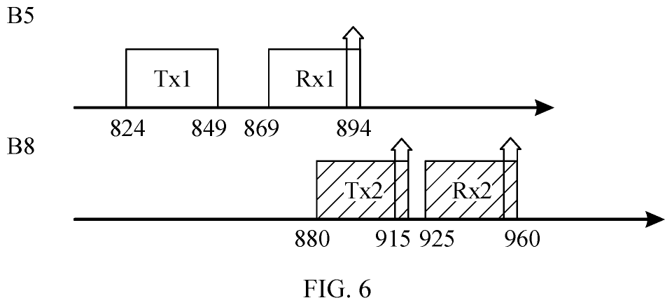

FIG. 6 illustrates the frequency overlap of transmissions and receptions further causing desense of a receiver. As shown, the Tx band (labeled “Tx1”) for B5 may be adjacent to the Rx band (labeled “Rx1” for B5), and the Tx band (labeled “Tx2”) for B8 may be adjacent to the Rx band (labeled “Rx2”) for B8. Rx1 for B5 may overlap with Tx2 for B8. Therefore, the transmission on B8 may not be attenuated by the filter (e.g., filter 408) in the DRx path, further causing desensitization of the received page signal.

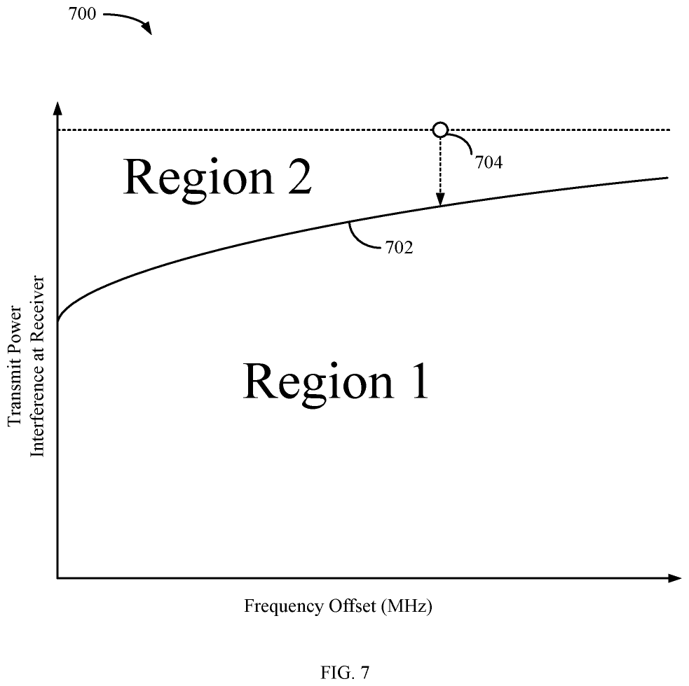

FIG. 7 is a graph 700 having a curve 702 representing a level of transmit power interference at a receiver (e.g., at the input of LNA 422) as a function of transmit frequency offset (e.g., offset between the transmit frequency of Sub1 and receive frequency for a page for Sub2, referred to as “Frequency Offset”). As the frequency offset reduces, the transmit power interference increases, reducing the SNR. If a wireless device is operating in region 1 (e.g., below curve 702), no Tx backoff (e.g., or blanking) may be used. Operating on curve 702 may result in the absolute SNR dropping by 1 dB or more from a maximum SNR associated with page reception. As the wireless device transitions from region 1 to region 2 (e.g. transitions from below the curve 702 to above the curve 702), the SNR continues to drop due to the increased transmit power interference at the receiver. When the wireless device operates in region 2, the amount of Tx backoff to be implemented may be the difference between the current transmit power and the transmit power associated with operating on the curve 702. For instance, if the wireless device is operating at operating point 704, the transmit power may be reduced as shown so that the device operates on the curve 702.

In certain aspects, the transmit power during page decoding may be calculated using the equation:

Tx=G_{ANT-ANT}+TxRej−SPN−FE_Gain/Rx_IL+[(−174(dBm/Hz)+NF(SDR+qLNA)+FE loss)+F(DA_RxBN)+F(Tx_IM 2)+RSRP+(IPN+RSB)_{LA}−10*log 10(SCS)]_{LA}−6dB
Where Tx is the transmit power of Sub1 at the antenna (Ant1) for the PRx path, G_{ANT-ANT} represents the isolation for Sub1 transmit frequencies from Ant1 to Ant2 (e.g., antenna for the DRx path), TxRej represents the rejection offered by the front-end to transmission traffic in DRx path, SPN is the low-power synthesizer spot phase noise at a given offset at which Tx of Sub1 is present, FE_Gain/Rx_IL represents the gain/insertion loss in the paging signal path from the ANT port to the input of the RF transceiver, FE loss represents the insertion loss in the paging signal path from the ANT port to the input of first LNA, NF (radio+qLNA) represents the cascaded noise figure associated with the radio (e.g., radio 402) and LNA (e.g., LNA 422), F (DA_RxBN) represents receive band noise generated at the radio transmit output port (e.g., transmit output port of radio 402) and referred at the ANT2, F (Tx_IM2) represents the second order intermodulation noise generated at the DRx mixer (e.g., mixer 472) due to the transmission traffic, SCS is the subcarrier spacing, IPN is the integrated phase noise of the low-power synthesizer (e.g., synthesizer 493), RSRP is the reference signal receive power associated with a received page, RSB is the residual sideband noise due to the low-power synthesizer and gain and phase mismatches in the RF signal path between I and Q chains, and LA indicates to perform log addition.

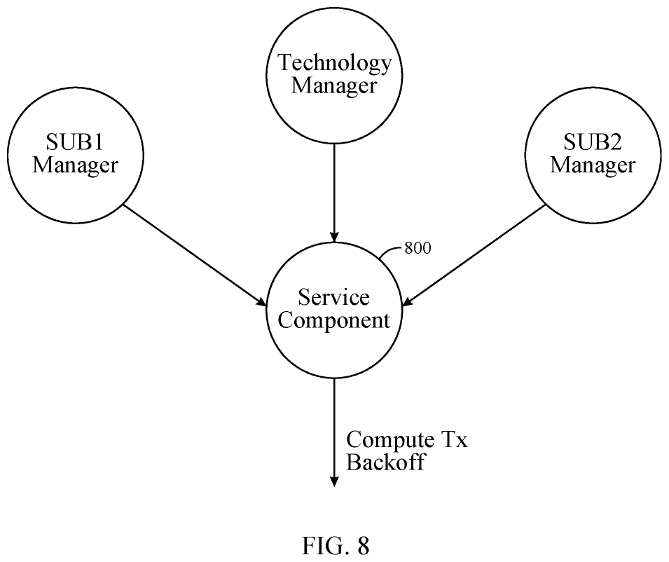

FIG. 8 illustrates a service component 800 (e.g., a controller, such as the controller 280 of FIG. 2) used to calculate a Tx backoff, in accordance with certain aspects of the present disclosure. As shown, the component 800 may receive various parameters associated with Sub1, Sub2, and communication technology which are used to calculate the Tx backoff during paging. For example, the component 800 may receive, from a Sub1 manager, RSRP, transmit power level, SNR, and uplink (UL) absolute radio-frequency channel number (ARFCN). The component 800 may receive, from a Sub2 manager, RSRP, SNR, and downlink (DL) ARFCN. The component 800 may receive, from a technology manager (e.g., manager of the radio access technology, such as long-term evolution (LTE) or new radio (NR)), transmission rejection, antenna to antenna isolation, and front-end gain. Based on these parameters, the component 800 may calculate the Tx backoff to be used during paging.

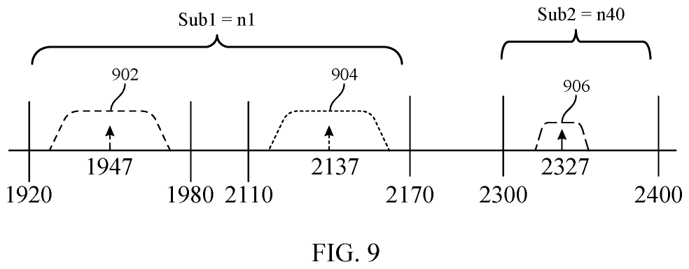

FIG. 9 illustrates an intermodulation product that causes down-conversion (e.g., via mixer 472) of a transmission signal, which may cause issues with page decoding. For example, as shown, Sub1 reception may occur at f1 (2137 MHz in band 904), Sub2 reception may occur at f2 (2327 MHz in band 906), and transmission may occur at 1947 MHz in band 902. The generated intermodulation product may be equal to 2f1-f2 (e.g., 2×2137 MHz-2327 MHz), which may be equal to 1947 MHz falling within the transmission band 902. In some cases, a frequency shift may be applied to receive frequency f1. For example, with a shift of −12.5 MHz in the Sub1 reception frequency, the intermodulation product may have a frequency of 1922 MHz which still falls within the transmission band. To have the intermodulation product fall completely outside the transmission band, a 50 MHz frequency shift may have to be used, which may not be possible in some implementations. In some aspects of the present disclosure, to avoid (or at least reduce) the down-conversion of the transmit signal due to the LO intermodulation product, Tx backoff, frequency shift, or both Tx backoff and frequency shift may be used.

In some cases, the Sub1 transmission harmonic may fall on the Sub2 receive band, causing issues with page decoding. For example, Sub1 transmission harmonics may be generated at the drive amplifier (DA) (e.g., DA 316 of FIG. 3) and/or PA (e.g., PA 318 or PA 404 of FIG. 4) used for signal transmission of Sub1. At least a portion of the transmission signal harmonics may be rejected by the duplexer and triplexer (e.g., duplexer 410 or triplexer/diplexer 412). Transmission harmonics may couple from antennas (e.g., from Ant1 to Ant2) and desense the page. In some aspects of the present disclosure, the Tx harmonics power may be reduced (e.g., to be 6 dB below the noise floor) by performing Tx backoff as described.

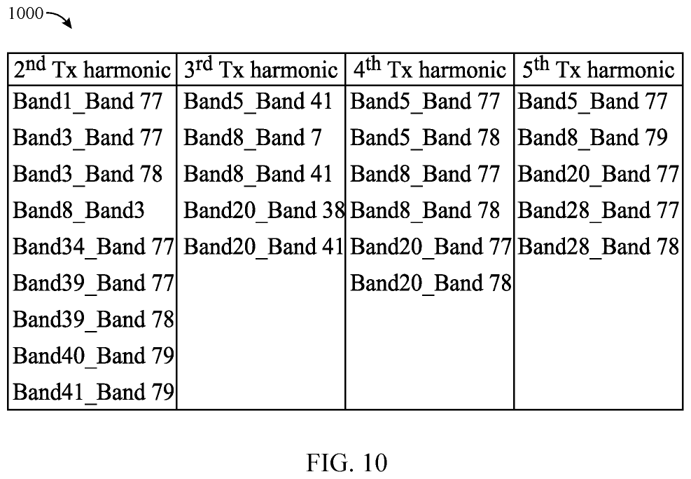

FIG. 10 is a table 1000 illustrating example band combinations that may be associated with respective Tx backoff levels, in accordance with certain aspects of the present disclosure. For example, each of the band combinations may be characterized on a wireless device (e.g., using device testing or simulations), and an associated Tx backoff that facilitates reception of a page may be identified (e.g., a Tx backoff that provides a 1 dB desense or an SNR that is 1 dB below a maximum SNR associated with the page reception) and mapped to the band combination. For example, band combinations may be analyzed based on a harmonic associated with the transmission on Sub1 overlapping with a frequency used for page reception on Sub2. For instance, in the first column of the table 1000 labeled “2nd Tx harmonic,” the combination labeled “Band1 Band 77” refers to Sub1 using Band1 and Sub2 using Band 77, where the second harmonic of the transmission on Sub1 overlaps with a frequency associated with the page reception on Sub2. The band combinations from table 1000 and associated Tx backoff (e.g., maximum Tx power limits) may be stored in memory, allowing a controller (e.g., driver) to select a Tx backoff from the table 1000 based on a configured band combination.

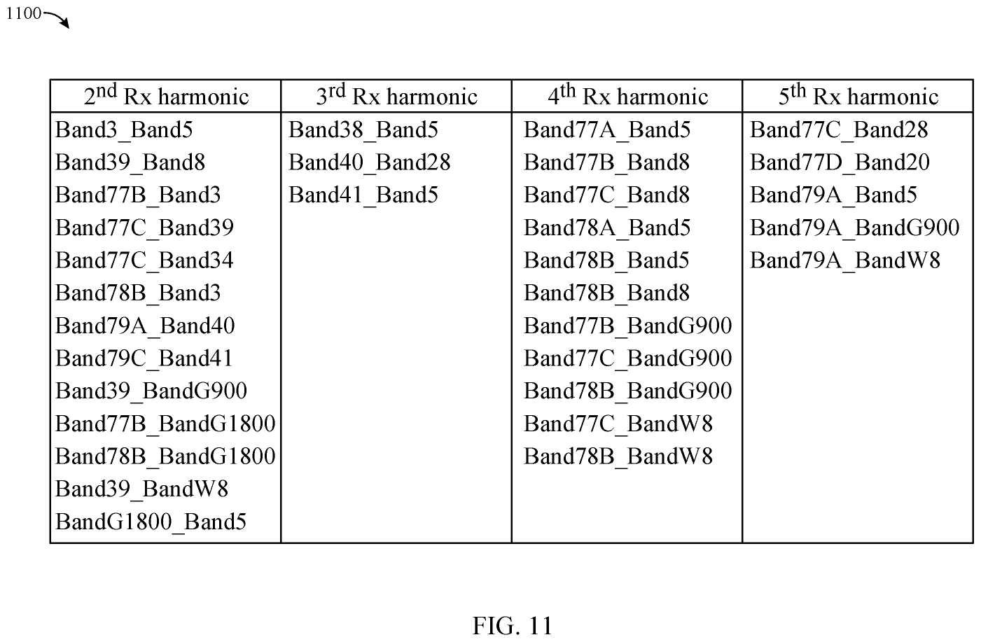

FIG. 11 is a table 1100 illustrating example band combinations that may be associated with respective Tx backoff levels, in accordance with certain aspects of the present disclosure. For example, each of the band combinations may be characterized on a wireless device (e.g., using device testing or simulations), and an associated Tx backoff that facilitates reception of a page may be identified (e.g., a Tx backoff that provides a 1 dB desense or an SNR that is 1 dB below a maximum SNR associated with the page reception) and mapped to the band combination. In this case, band combinations may be analyzed based on a harmonic of an LO signal for the page reception causing unintentional down-conversion of the Sub1 transmission. For instance, in the first column of the table labeled “2nd Rx harmonic,” the combination labeled “Band3_Band5” refers to the second harmonic of the LO signal for page reception using Band_5 on Sub2 causing down-conversion of the transmission on Sub1 using Band_3. The band combinations from table 1100 and associated Tx backoff (e.g., or maximum Tx power limits) may be stored in memory, allowing a controller (e.g., driver) to select a Tx backoff from the table 1100 based on a configured band combination.

Certain aspects of the present disclosure provide for backing off the transmit power level of Sub1 dynamically through on-the-fly computations to facilitate page decode in MSIM applications employing synthesizers with poor phase noise. Certain aspects enable area savings and reduced power dissipation by employing poor phase noise synthesizers to accomplish the goal of page decode in MSIM applications.

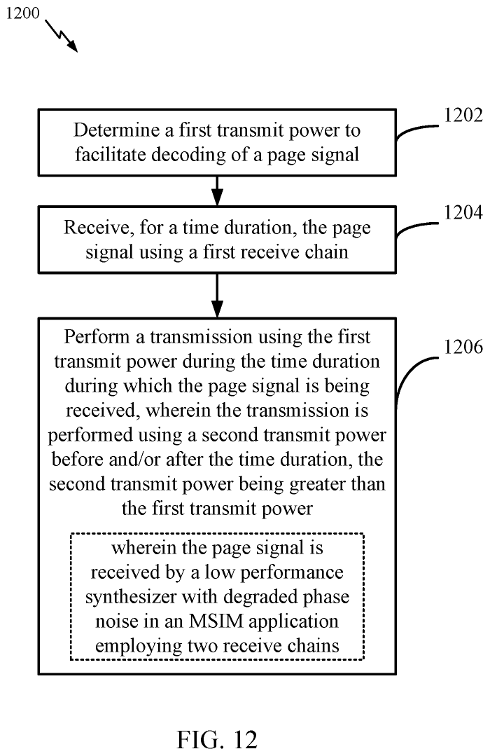

FIG. 12 is a flow diagram illustrating example operations 1200 for wireless communication, in accordance with certain aspects of the present disclosure. The operations 1200 may be performed, for example, by a wireless device, such as the wireless device 400, which may include a controller such as the controller 280 of FIG. 2.

At block 1202, the wireless device may determine a first transmit power to facilitate decoding of a page signal. At block 1204, the wireless device receives, for a time duration, the page signal using a first receive chain (e.g., chain 492 of FIG. 4).

At block 1206, the wireless device performs a transmission using the first transmit power during the time duration in which the page signal is being received. The transmission may be performed using a second transmit power after the time duration, the second transmit power being greater than the first transmit power. The transmission may be performed for a first subscriber, and the page signal may be received for a second subscriber (e.g., Sub2) different than the first subscriber.

The first transmit power may be determined such that a SNR associated with the reception of the page signal is 1 dB less than a maximum SNR associated with the reception of the page signal. The first transmit power may be determined based on a difference between a first frequency associated with the transmission and a second frequency associated with the reception of the page signal.

In some aspects, the wireless device may perform a reception using a second receive chain (chain 490 of FIG. 4) while receiving the page signal on chain 492. The first transmit power may be determined based on an intermodulation product associated with the reception of the page signal using the first receive chain and the reception of traffic using the second receive chain. In some aspects, the wireless device may shift a frequency at which the page signal is received based on the intermodulation product.

In some aspects, the first transmit power may be determined based on a configured transmit power for each of a plurality of band combinations (e.g., band combinations shown in tables 1000, 1100). The configured transmit power may be determined based on a harmonic associated with the transmission overlapping with a frequency associated with the reception of the page signal. The configured transmit power may be determined based on a harmonic associated with the reception of the page signal causing down-conversion (e.g., unintentional down-conversion) of the transmission. In some aspects, each of the plurality of band combinations may include a first band associated with the transmission and a second band associated with the reception of the page signal.

In some aspects, the wireless device may include an uplink transmit chain and a downlink pipe, where the downlink pipe includes at least first and second downlink receive chains (e.g., referred to herein as a primary receive chain (PRx) and a secondary receive chain (DRx), respectively). The first and second receive chains may function as a diversity receiver for reception in a single band or may function as two independent chains either for single chain reception for receiving in a single band or for a multi-SIM (MSIM) application to receive in two different bands belonging to the same radio access technology (RAT) or different RATs.

The first and second receive chains may be driven by a high-performance synthesizer or a low-power synthesizer. The high-performance synthesizer may be used for traffic reception having a high signal-to-noise ratio (SNR) specification, and the low-performance synthesizer may be used for receiving and demodulating signals with a low SNR specification. The high-performance synthesizer may drive the first receive chain, and the second receive chain may be driven by the low-power synthesizer, or vice versa, for an MSIM application.

### Example Aspects

In addition to the various aspects described above, specific combinations of aspects are within the scope of the present disclosure, some of which are detailed below:

Aspect 1: A method for wireless communication, comprising: determining a first transmit power to facilitate decoding of a page signal; receiving, for a time duration, the page signal using a first receive chain; and performing a transmission using the first transmit power during the time duration in which the page signal is being received, wherein the transmission is performed using a second transmit power before or after the time duration, the second transmit power being greater than the first transmit power.

Aspect 2: The method of Aspect 1, wherein the transmission is performed for a first subscriber, and wherein the page signal is received for a second subscriber different than the first subscriber.

Aspect 3: The method of Aspect 1 or 2, wherein the first transmit power is determined such that a signal-to-noise ratio (SNR) associated with the reception of the page signal is at least 1 dB less than a maximum SNR associated with the reception of the page signal.

Aspect 4: The method according to any of Aspects 1-3, wherein the first transmit power is determined based on a difference between a first frequency associated with the transmission and a second frequency associated with the reception of the page signal.

Aspect 5: The method according to any of Aspects 1-4, further comprising performing a reception using a second receive chain while receiving the page signal, wherein the first transmit power is determined based on an intermodulation product of mixer local oscillator frequencies associated with the reception of the page signal using the first receive chain and the reception using the second receive chain.

Aspect 6: The method of Aspect 5, further comprising shifting one of the mixer local oscillator frequencies at which the page signal is received based on the intermodulation product.

Aspect 7: The method according to any of Aspects 1-6, wherein the first transmit power is determined based on a configured transmit power for each of a plurality of band combinations.

Aspect 8: The method of Aspect 7, wherein the configured transmit power is determined based on a harmonic associated with the transmission overlapping with a frequency associated with the reception of the page signal.

Aspect 9: The method of Aspect 7 or 8, wherein the configured transmit power is determined based on a harmonic associated with the reception of the page signal causing down-conversion of transmitted signal appearing at an input of the first receive chain receiving the page signal.

Aspect 10: The method according to any of Aspects 7-9, wherein each of the plurality of band combinations comprises a first band associated with the transmission and a second band associated with the reception of the page signal.

Aspect 11: An apparatus for wireless communication, comprising: a memory; and one or more processors coupled to the memory, the one or more processors being configured to: determine a first transmit power to facilitate decoding of a page signal, wherein the page signal is configured to be received for a time duration using a first receive chain; and cause a transmission to be performed using the first transmit power during the time duration in which the page signal is being received, wherein the transmission is caused to be performed using a second transmit power before or after the time duration, the second transmit power being greater than the first transmit power.

Aspect 12: The apparatus of Aspect 11, wherein the transmission is performed for a first subscriber, and wherein the page signal is received for a second subscriber different than the first subscriber.

Aspect 13: The apparatus of Aspect 11 or 12, wherein the first transmit power is determined such that a signal-to-noise ratio (SNR) associated with the reception of the page signal is 1 dB less than a maximum SNR associated with the reception of the page signal.

Aspect 14: The apparatus according to any of Aspects 11-13, wherein the one or more processors are configured to determine the first transmit power based on a difference between a first frequency associated with the transmission and a second frequency associated with the reception of the page signal.

Aspect 15: The apparatus according to any of Aspects 11-14, wherein a reception is configured to be performed using a second receive chain while receiving the page signal, and wherein the one or more processors are configured to determine the first transmit power based on an intermodulation product of mixer local oscillator frequencies associated with the reception of the page signal using the first receive chain and the reception using the second receive chain.

Aspect 16: The apparatus of Aspect 15, wherein the one or more processors are configured to cause a shift of one of the mixer local oscillator frequencies at which the page signal is received based on the intermodulation product.

Aspect 17: The apparatus according to any of Aspects 11-16, wherein the one or more processors are configured to determine the first transmit power based on a configured transmit power for each of a plurality of band combinations.

Aspect 18: The apparatus of Aspect 17, wherein the configured transmit power is determined based on a harmonic associated with the transmission overlapping with a frequency associated with the reception of the page signal.

Aspect 19: The apparatus of Aspect 17 or 18, wherein the configured transmit power is determined based on a harmonic associated with the reception of the page signal causing down-conversion of a transmitted signal appearing at an input of the first receive chain receiving the page signal.

Aspect 20: The apparatus according to any of Aspects 11-19, further comprising: a second receive chain; a low-power synthesizer (LPM) configured to drive a mixer of one of the first receive chain and the second receive chain; and a high-power synthesizer (HPM) configured to drive a mixer of another one of the first receive chain and the second receive chain.

Aspect 21: The apparatus of Aspect 20, wherein the first receive chain and the second receive are configured to operate as a diversity receiver for reception in a single band or configured to operate as two independent receive chains for reception in the single band or, for a multi-subscriber identity module (MSIM) application, for receiving in two different bands belonging to a radio access technology (RAT) or different RATs.

Aspect 22: A non-transitory computer-readable medium having instructions stored thereon, that when executed by one or more processors, cause the one or more processors to: determine a first transmit power to facilitate decoding of a page signal, wherein the page signal is configured to be received for a time duration using a first receive chain; and cause a transmission to be performed using the first transmit power during the time duration in which the page signal is being received, wherein the transmission is caused to be performed using a second transmit power before or after the time duration, the second transmit power being greater than the first transmit power.

The above description provides examples, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method which is practiced using other structure, functionality, or structure and functionality in addition to, or other than, the various aspects of the disclosure set forth herein. It should be understood that any aspect of the disclosure disclosed herein may be embodied by one or more elements of a claim.

The various operations of methods described above may be performed by any suitable means capable of performing the corresponding functions. The means may include various hardware and/or software component(s) and/or module(s), including, but not limited to a circuit, an application-specific integrated circuit (ASIC), or processor. Generally, where there are operations illustrated in figures, those operations may have corresponding counterpart means-plus-function components.

As used herein, a phrase referring to “at least one of” a list of items refers to any combination of those items, including single members. As an example, “at least one of: a, b, or c” is intended to cover: a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

It is to be understood that the claims are not limited to the precise configuration and components illustrated above. Various modifications, changes, and variations may be made in the arrangement, operation, and details of the methods and apparatus described above without departing from the scope of the claims.

1. A method for wireless communication, comprising:
determining a first transmit power to facilitate decoding of a page signal;
receiving, for a time duration, the page signal using a first receive chain; and
performing a transmission using the first transmit power during the time duration in which the page signal is being received, wherein the transmission is performed using a second transmit power before or after the time duration, the second transmit power being greater than the first transmit power.

2. The method of claim 1, wherein the transmission is performed for a first subscriber, and wherein the page signal is received for a second subscriber different than the first subscriber.

3. The method of claim 1, wherein the first transmit power is determined such that a signal-to-noise ratio (SNR) associated with the reception of the page signal is at least 1 dB less than a maximum SNR associated with the reception of the page signal.

4. The method of claim 1, wherein the first transmit power is determined based on a difference between a first frequency associated with the transmission and a second frequency associated with the reception of the page signal.

5. The method of claim 1, further comprising performing a reception using a second receive chain while receiving the page signal, wherein the first transmit power is determined based on an intermodulation product of mixer local oscillator frequencies associated with the reception of the page signal using the first receive chain and the reception using the second receive chain.

6. The method of claim 5, further comprising shifting one of the mixer local oscillator frequencies at which the page signal is received based on the intermodulation product.

7. The method of claim 1, wherein the first transmit power is determined based on a configured transmit power for each of a plurality of band combinations.

8. The method of claim 7, wherein the configured transmit power is determined based on a harmonic associated with the transmission overlapping with a frequency associated with the reception of the page signal.

9. The method of claim 7, wherein the configured transmit power is determined based on a harmonic associated with the reception of the page signal causing down-conversion of transmitted signal appearing at an input of the first receive chain receiving the page signal.

10. The method of claim 7, wherein each of the plurality of band combinations comprises a first band associated with the transmission and a second band associated with the reception of the page signal.

11. An apparatus for wireless communication, comprising:
a memory; and
one or more processors coupled to the memory, the one or more processors being configured to:
determine a first transmit power to facilitate decoding of a page signal, wherein the page signal is configured to be received for a time duration using a first receive chain; and
cause a transmission to be performed using the first transmit power during the time duration in which the page signal is being received, wherein the transmission is caused to be performed using a second transmit power before or after the time duration, the second transmit power being greater than the first transmit power.

12. The apparatus of claim 11, wherein the transmission is performed for a first subscriber, and wherein the page signal is received for a second subscriber different than the first subscriber.

13. The apparatus of claim 11, wherein the first transmit power is determined such that a signal-to-noise ratio (SNR) associated with the reception of the page signal is 1 dB less than a maximum SNR associated with the reception of the page signal.

14. The apparatus of claim 11, wherein the one or more processors are configured to determine the first transmit power based on a difference between a first frequency associated with the transmission and a second frequency associated with the reception of the page signal.

15. The apparatus of claim 11, wherein a reception is configured to be performed using a second receive chain while receiving the page signal, and wherein the one or more processors are configured to determine the first transmit power based on an intermodulation product of mixer local oscillator frequencies associated with the reception of the page signal using the first receive chain and the reception using the second receive chain.

16. The apparatus of claim 15, wherein the one or more processors are configured to cause a shift of one of the mixer local oscillator frequencies at which the page signal is received based on the intermodulation product.

17. The apparatus of claim 11, wherein the one or more processors are configured to determine the first transmit power based on a configured transmit power for each of a plurality of band combinations.

18. The apparatus of claim 17, wherein the configured transmit power is determined based on a harmonic associated with the transmission overlapping with a frequency associated with the reception of the page signal.

19. The apparatus of claim 17, wherein the configured transmit power is determined based on a harmonic associated with the reception of the page signal causing down-conversion of a transmitted signal appearing at an input of the first receive chain receiving the page signal.

20. A non-transitory computer-readable medium having instructions stored thereon, that when executed by one or more processors, cause the one or more processors to:
determine a first transmit power to facilitate decoding of a page signal, wherein the page signal is configured to be received for a time duration using a first receive chain; and
cause a transmission to be performed using the first transmit power during the time duration in which the page signal is being received, wherein the transmission is caused to be performed using a second transmit power before or after the time duration, the second transmit power being greater than the first transmit power.
